(19) United States
(12) Patent Application Publication
(10) Pub. No.: US 2011/0125758 A1
(43) Pub. Date: May 26, 2011

(54) Collaborative Automated Structured Tagging

(75) Inventors: Andrea Basso, Marlboro, NJ (US); Bernard S. Renger, New Providence, NJ (US)

(73) Assignee: AT&T INTELLECTUAL PROPERTY I, L.P., Reno, NV (US)

(21) Appl. No.: 12/623,912

(22) Filed: Nov. 23, 2009

(51) Int. Cl. G06F 17/30

(52) U.S. Cl. 707/748; 707/E17.033

(57) ABSTRACT

A collaborative automated structured tagging method, apparatus, and computer readable medium generate tags for an asset based on context items and the content of the asset. The tags are then ranked and stored until requested by a user or system. Users viewing the asset and the ranked tags can select tags indicating that the tags correctly define the asset. Users can also enter new tags for assets. The user input is then used to re-rank the tags associated with the particular asset.

### BACKGROUND OF THE INVENTION

The present invention relates generally to data management, and more particularly to tagging assets based on context and content.

A large amount of information is available on the Internet. This voluminous amount of information and lack of identification or definition of this information makes it difficult for users to find specific information.

A piece of information, also known as an asset, is tagged to define its content and, in some cases, aid in classifying the asset. An asset is specific content such as an image, a video, an audio clip, etc. A tag is a word or phrase used to describe, categorize, or define the content of an asset. Tags are typically generated either freeform with no proposed tags or structured using an annotation guide listing possible tags. Freeform tags are assigned to assets by taggers based on a tagger's interpretation of the asset and the tagger's vocabulary. Structured tags are tags selected and assigned to an asset by users from an annotation or tagging guide comprised of a plurality of tags.

Structured tagging promotes uniformity while free form tagging allows for unconstrained tags. However, both of these types of tagging produce tags that do not promote efficient searching of assets. Further, some tags are static and a user may not be allowed to change tags as the context of a particular asset changes over time. What is needed is a method of tagging assets that promotes more efficient defining of assets.

### BRIEF SUMMARY OF THE INVENTION

The present invention provides a method and apparatus and computer readable medium for collaborative automated structured tagging. Embodiments of the present invention identify context items associated with an asset and the content of an asset in order to generate tags. The generated tags are then ranked and stored in a database for, in one embodiment, presentation to a user. Tags presented to a user, in one embodiment, may be selected by the user to indicate that the selected tags appropriately define the asset. Users may also enter new tags to be associated with an asset. The user input is then used to re-rank the tags associated with the asset.

These and other advantages of the invention will be apparent to those of ordinary skill in the art by reference to the following detailed description and the accompanying drawings.

### BRIEF DESCRIPTION OF THE DRAWINGS

FIG. 1 shows a collaborative automated structured tagging apparatus;

FIG. 2 is a flowchart depicting a method of tagging assets according to one embodiment of the present invention; and

FIG. 3 is a high-level block diagram of a computer that may be used to implement the collaborative automated structured tagging apparatus of FIG. 1.

### DETAILED DESCRIPTION

An asset is electronic information comprised of one of more mediums. For example an asset may be an image or audio clip. An asset may also be text such as an article or book. A tag is a word or phrase used to define the content of an asset. An asset may have more than one tag associated with it.

Briefly, in one embodiment of the present invention, tags for a newly acquired asset are automatically generated based on context items and content analysis of asset. The initially generated tags may then be ranked according to criteria such as occurrence. The asset and associated tags are then made available to users. A user may view the asset and tags and select tags that the user believes to best define the asset. A user may also enter new tags for consideration by other users. After a user has selected and/or entered tags, the ranking of the tags associated with the asset are updated to reflect the user input as necessary.

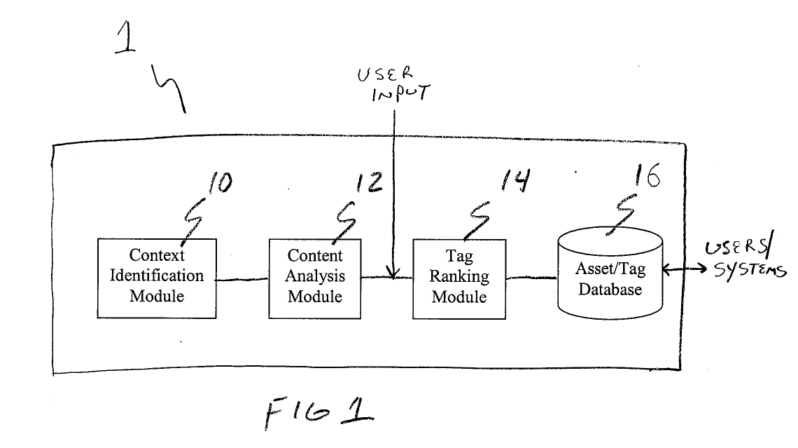

FIG. 1 depicts one embodiment of collaborative automated structured tagging apparatus 1 utilizing modules to generate tags for assets. Context item identification module 10 is configured to receive assets and identify the context items associated with the assets. Context item identification module 10 is in communication with content analysis module 12. Context item identification module 10 is configured to transmit assets and tags representing the identified context items associated with each particular asset to content analysis module 12.

Content analysis module 12 analyzes assets to determine the content of each particular asset. A particular asset may be analyzed using one or more techniques depending on the medium of the asset with the analysis resulting in the generation of tags. The tags are thereby generated automatically and have a structure based on the operation of context identification module 10 and content analysis module 12. An asset and the tags generated based on context item identification and content analysis are output from content analysis module 12 to tag ranking module 14 which is in communication with content analysis module 12.

Tag ranking module 14 ranks tags associated with a particular asset and outputs assets and their associated ranked tags to asset/tag database 16 where the assets and tags are stored. Tag ranking module 14 may also receive information associated with tags related to a particular asset from a user.

Tags associated with a particular asset are output from database 16 in response to user requests received directly or indirectly from a user.

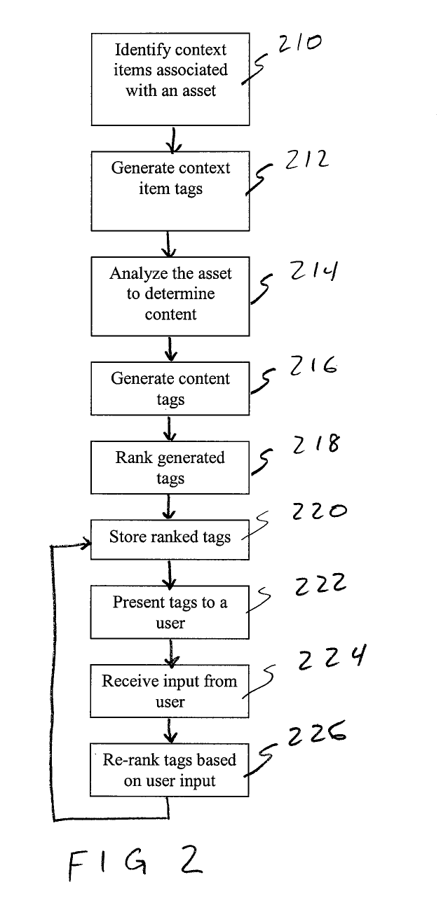

The operation of the modules depicted in FIG. 1 will now be described in connection with FIG. 2. At step 210, an asset is examined by context identification module 10 which identifies context items associated with the asset. At step 212, context identification module 10 generates context item tags based on the asset. At step 214, the asset is analyzed by content analysis module 12 to determine the content of the asset.

Different methods of analysis may be used depending on the medium of the asset. For example, if the asset is an image or picture, pattern recognition may be used to determine what the image depicts. Object recognition may be used to identify objects depicted in the image such as vehicles, scenes, humans, and animals. Facial recognition may be used to further identify a human as a particular person. The content data representing audio may be analyzed using speech recognition or pattern recognition. Data representing video may be analyzed using techniques similar to those used for image analysis on a frame by frame basis. There are various well known techniques for determining the content of an asset. For example, see U.S. Pat. No. 6,714,909 issued Mar. 30, 2004 entitled “System and Method for Automated Multimedia Content Indexing and Retrieval.” Since there are various well known techniques for determining the content of an asset, these techniques will not be described further herein.

At step 216, tags are generated based on the content analysis of the asset by module 12. Tags generated by modules 10 and 12 are then input into tag ranking module 14. Module 14 ranks the tags according to one or more methods such as statistical analysis. Tags may be ranked based on values such as, for example, the number of times specific content occurs in an asset, a score based on specific content of an asset and the relevancy of the specific content, or the percentage of specific content with respect to the total content of the asset. The asset and the ranked tags are then output from module 14 to asset/tag database 16.

At step 222 a particular asset and the tags associated with the asset are presented to the user. In one embodiment, the asset and associated tags are presented in response to a user requesting the asset. At step 224, the user can select tags that the user believes to be most relevant or best defines the asset. A user can also enter new tags to be associated with the asset.

At step 226, tags related to the asset are re-ranked based on user input received in step 224. The process for a particular asset then proceeds to step 220 where the tags re-ranked in step 226 are stored in asset/tag database 16 where they remain until the particular asset is again presented to a user and process steps 222 through 226 are repeated.

Since user input may be used to update the tags associated with a particular asset, and multiple users may input tag information, the resulting tags benefit from multiple users collaborating to define the asset. In addition, the user input allows for the tags defining an asset to change over time. For example, a picture of a person may be tagged based on the identity of the person and the context in which the picture was taken. Should the picture take on additional significance in the future, for example, the picture being the last taken of the person while the person was alive, users can input additional tags indicating this information.

It should be noted that asset/tag database 16 may be accessed based on user requests for assets and other systems requiring tags for assets. For example, database 16 may be accessed by the image and video hosting website/web service Flicker or the social news website Digg.

Database 16, in one embodiment, may be configured to store pointers or identifiers associated with assets rather than storing the actual assets which would then be stored elsewhere.

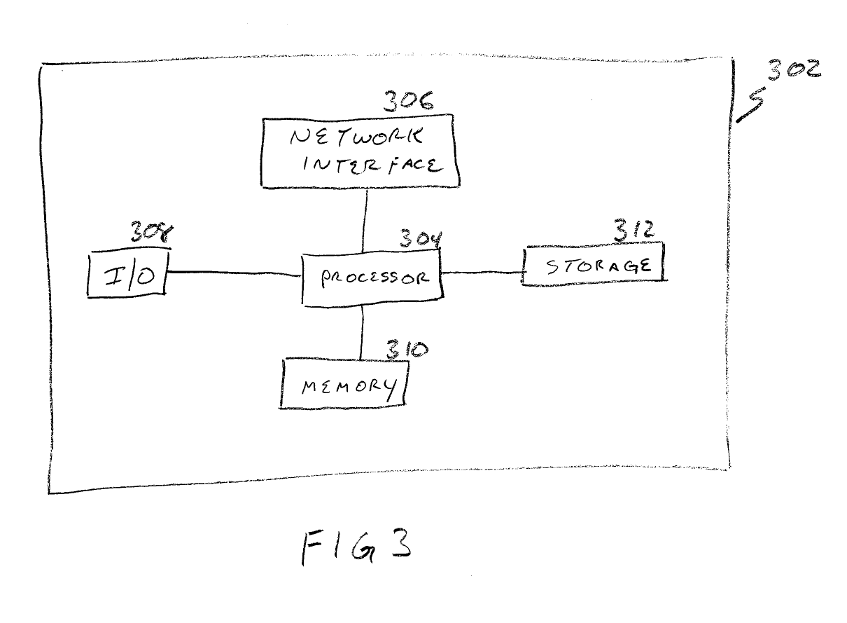

Collaborative automated structured tagging apparatus 1 may be implemented using a computer. A high-level block diagram of such a computer is illustrated in FIG. 3. Computer 302 contains a processor 304 which controls the overall operation of the computer 302 by executing computer program instructions which define such operation. The computer program instructions may be stored in a storage device 312, or other computer readable medium (e.g., magnetic disk, CD ROM, etc.), and loaded into memory 310 when execution of the computer program instructions is desired. Thus, the method steps of FIG. 2 can be defined by the computer program instructions stored in the memory 310 and/or storage 312 and controlled by the processor 304 executing the computer program instructions. For example, the computer program instructions can be implemented as computer executable code programmed by one skilled in the art to perform an algorithm defined by the method steps of FIG. 2. Accordingly, by executing the computer program instructions, the processor 304 executes an algorithm defined by the method steps of FIG. 2. The computer 302 also includes one or more network interfaces 306 for communicating with other devices via a network. The computer 302 also includes input/output devices 308 that enable user interaction with the computer 302 (e.g., display, keyboard, mouse, speakers, buttons, etc.) One skilled in the art will recognize that an implementation of an actual computer could contain other components as well, and that Figure. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer implemented method for collaborative automated structured tagging comprising the steps of:
identifying context items associated with an asset;
generating context item tags based on identified context items associated with the asset;
analyzing the asset to determine asset content;
generating asset content tags based on determined asset content;
ranking generated context item tags and asset content tags; and
storing ranked tags associated with the asset.

2. The method of claim 1 further comprising the steps of:
presenting ranked tags associated with an asset to a user;
receiving input from the user representing tagging information related to the asset; and
re-ranking tags associated with the asset based on the user input and previous tag rankings associated with the asset.

3. The method of claim 2 wherein the input from a user representing tagging information is user selection of at least one tag associated with the asset.

4. The method of claim 2 wherein the input from a user representing tagging information is at least one tag entered by the user.

5. The method of claim 2 wherein re-ranking tags associated with the asset based on the user input and previous tag rankings associated with the asset is performed using statistical analysis.

6. An apparatus for collaborative automated structured tagging comprising:
means for identifying context items associated with an asset;
means for generating context item tags based on identified context items associated with the asset;
means for analyzing the asset to determine asset content;
means for generating asset content tags based on determined asset content;
means for ranking generated context item tags and asset content tags; and
means for storing ranked tags associated with the asset.

7. The apparatus of claim 6 further comprising:
means for presenting tags associated with an asset to a user;
means for receiving input from a user representing tagging information related to the asset; and
means for re-ranking tags associated with the asset based on the user input and previous tag rankings associated with the asset.

8. The apparatus of claim 7 wherein the input from a user representing tagging information is user selection of at least one tag associated with the asset.

9. The apparatus of claim 7 wherein the input from a user representing tagging information is at least one tag entered by the user.

10. The apparatus of claim 7 wherein re-ranking tags associated with the asset based on the user input and previous tag rankings associated with the asset is performed using statistical analysis.

11. A computer readable medium having stored thereon computer executable instructions for collaborative automated structured tagging, the computer executable instructions defining steps comprising:
identifying context items associated with an asset;
generating context item tags based on identified context items associated with the asset;
analyzing the asset to determine asset content;
generating asset content tags based on determined asset content;
ranking generated context item tags and asset content tags; and
storing ranked tags associated with the asset.

12. The computer readable medium of claim 11, further comprising computer executable instructions defining the steps of:
presenting ranked tags associated with an asset to a user;
receiving input from the user representing tagging information related to the asset; and
re-ranking tags associated with the asset based on the user input and previous tag rankings associated with the asset.

13. The computer readable medium of claim 12 wherein the input from a user representing tagging information is user selection of at least one tag associated with the asset.

14. The computer readable medium of claim 12 wherein the input from a user representing tagging information is at least one tag entered by the user.

15. The computer readable medium of claim 12 wherein re-ranking tags associated with the asset based on the user input and previous tag rankings associated with the asset is performed using statistical analysis.
